(19) United States
(12) Patent Application Publication
(10) Pub. No.: US 2026/0245193 A1
(43) Pub. Date: Aug. 20, 2026

(54) MONITORING DEVICE AND METHOD OF OPERATING THE SAME

(71) Applicant: LG ENERGY SOLUTION, LTD., Seoul (KR)

(72) Inventors: Min Ji KIM, Daejeon (KR); Dong Hwan EOM, Daejeon (KR); Seung Gyun HONG, Daejeon (KR); Seung Jun LEE, Daejeon (KR)

(21) Appl. No.: 19/155,873

(22) PCT Filed: Mar. 29, 2024
(86) PCT No.: PCT/KR2024/004091

§ 371 Date: Aug. 12, 2025

(30) Foreign Application Priority Data
Apr. 3, 2023 (KR) 10-2023-0043688

(51) Int. Cl. G06T 7/00; G06V 10/764; G06V 10/82; H01M 10/42

(52) U.S. Cl. CPC G06T 7/0004; G06V 10/764; G06V 10/82; H01M 10/4285; G06T 2207/20081; G06T 2207/20084

(57) ABSTRACT

A monitoring device includes an image acquisition unit configured to capture an image at least one process processing device involved in the manufacturing of a battery cell, a state determination unit configured to generate a first determination result by analyzing the acquired image using an artificial intelligence model trained to assess the condition of a top insulator of the battery cell and determine whether the battery cell is defective, and a determination unit configured to determine whether the battery cell is defective based on the first determination result.

### CROSS-REFERENCE TO RELATED APPLICATION

This application is a National Phase entry pursuant to 35 U.S.C. 371 of International Application PCT/KR2024/004091 filed on Mar. 29, 2024, which claims priority to and the benefit of Korean Patent Application No. 10-2023-0043688 filed in the Korean Intellectual Property Office on Apr. 3, 2023, the entire contents of which are incorporated herein by reference.

### TECHNICAL FIELD

The present disclosure relates to a monitoring device and a method of operating the same.

### BACKGROUND

A battery cell is classified into cylindrical, prismatic, and pouch types according to the type of a battery case, and the cylindrical battery cell may include an electrode assembly, a battery case of a cylindrical metal can that accommodates the electrode assembly and an electrolyte solution, and a cap assembly assembled above the cylindrical can.

The electrode assembly is formed by interposing a separator between a positive electrode plate formed by coating a positive electrode current collector with a positive electrode active material and a negative electrode plate formed by coating a negative electrode current collector with a negative electrode active material, and the electrode assembly may be manufactured in a jelly roll type, a stack type, or the like depending on the type of battery case and accommodated inside the battery case.

The battery cell may be manufactured through a series of manufacturing processes including an electrode manufacturing process, an assembly process, and a formation process. Here, the assembly process may include an operation of assembling a positive electrode plate and a negative electrode plate manufactured through the electrode manufacturing process and injecting an electrolyte solution inside thereof and include a notching operation, a winding operation, an assembly operation, and a packaging operation.

The packaging process may be defined as a process of injecting and sealing the electrode assembly and electrolyte into the battery case. The cylindrical battery cell is manufactured by mounting the electrode assembly on the cylindrical metal can, welding a negative electrode tab extending from a negative electrode of the electrode assembly to a lower end of the can, and welding a positive electrode tab extending from a positive electrode of the electrode assembly to a top cap of the cap assembly in a state in which the electrode assembly and the electrolyte are embedded.

A top insulator for covering an upper end of the electrode assembly is mounted on an upper surface of the electrode assembly to electrically insulate the electrode assembly and the cap assembly, and an electrode terminal may be connected to an electrode lead wire and connected to an external terminal.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

Embodiments disclosed herein are directed to providing a monitoring device capable of detecting a defective battery cell by accurately analyzing a state of a top insulator of a battery cell, and a method of operating the same.

The objects of embodiments disclosed herein are not limited to the above-described objects, and other objects that are not mentioned will be able to be clearly understood by those skilled in the art from the following descriptions.

A monitoring device according to one embodiment disclosed herein may include an image acquisition unit configured to acquire an image capturing at least one process processing device related to manufacturing of a battery cell, a state determination unit configured to generate a first determination result obtained by determining whether the battery cell is defective by inputting the acquired image into an artificial intelligence model configured to determine a state of a top insulator of the battery cell, and a determination unit configured to determine whether the battery cell is defective based on the first determination result.

A method of operating a monitoring device according to one embodiment disclosed herein may include an operation of acquiring an image capturing at least one process processing device related to manufacturing of a battery, an operation of generating a first determination result obtained by determining whether the battery cell is defective by inputting the acquired image into an artificial intelligence model configured to determine a state of a top insulator of the battery, and an operation of determining whether the battery cell is defective based on the first determination result.

According to the monitoring device and the method of operating the same according to one embodiment disclosed herein, it is possible to detect the defective battery cell by accurately analyzing the state of the top insulator of the battery cell.

The effects of the monitoring device and the method of operating the same according to the disclosure of the present document are not limited to the above-described effects, and other effects that are not mentioned will be able to be clearly understood by those skilled in the art according to the disclosure of the present document.

### BRIEF DESCRIPTION OF THE DRAWINGS

FIG. 1 is a block diagram of a monitoring device according to one embodiment of the present disclosure.

FIG. 2 shows a can assembly according to one embodiment of the present disclosure.

FIG. 3 is a view showing a battery unit having a top insulator and a battery unit without the top insulator according to one embodiment disclosed herein.

FIG. 4 shows an image showing foreign substance present inside the top insulator of the battery unit according to one embodiment disclosed herein.

FIG. 5 shows an image of the lifted top insulator of the battery unit according to one embodiment disclosed herein.

FIG. 6 is a view showing a state in which cracks are present in a beading area of the battery unit according to one embodiment disclosed herein.

FIG. 7 is a flowchart showing a method of operating the monitoring device according to one embodiment of the present disclosure.

In the description of the drawings, the same or similar reference numerals may be used for the same or similar components.

### DETAILED DESCRIPTION

Hereinafter, embodiments of the present disclosure will be described with reference to the accompanying drawings. However, it should be understood that this is not intended to limit the present disclosure to specific embodiments and includes various modifications, equivalents, and/or alternatives of the embodiments of the present disclosure.

It should be understood that the embodiments of the present document and the terms used herein are not intended to limit the technical features described herein to specific embodiments and include various modifications, equivalents, or substitutes of the corresponding embodiments. In the description of the drawings, similar reference numerals may be used for similar or related components. The singular form of a noun corresponding to an item may include one item or a plurality of items unless the relevant context clearly dictates otherwise.

In the present document, each of phrases such as “A or B,” “at least one of A and B,” “at least one of A or B,” “A, B, or C,” “at least one of A, B, and C,” and “at least one of A, B, or C” may include any one of the items listed together in the corresponding phrase among these phrases or all possible combinations thereof. Terms such as “first,” “second,” “first,” “second,” “A,” “B,” “(a),” or “(b)” may simply be used to distinguish the corresponding component from another and do not limit the corresponding components in another aspect (e.g., importance or order).

When a certain component (e.g., a first component) is described as being “coupled,” “connected,” or “joined” to another component (e.g., a second component) with or without the terms “functionally” or “communicatively” or “coupled” or “connected,” this means that the certain component may be connected to another component directly (e.g., by wire or wirelessly) or indirectly (e.g., through a third component).

A method according to various embodiments disclosed herein may be provided to be included in a computer program product. The computer program product may be traded between sellers and buyers as commodities. The computer program product may be distributed in the form of a device-readable storage medium (e.g., a compact disc read only memory (CD-ROM)) or distributed (e.g., downloaded or uploaded) through application stores or directly online between two user devices. In the case of the online distribution, at least some of the computer program products may be at least temporarily stored or temporarily generated in a device-readable storage medium such as a memory of a server of a manufacturer, a server of an application store, or a relay server.

According to the embodiments disclosed herein, each component (e.g., a module or a program) of the above-described components may include a single object or a plurality of objects, and some of the plurality of objects may be separately disposed in another component. According to the embodiments disclosed herein, one or more components or operations among the above-described corresponding components may be omitted, or one or more other components or operations may be added. Alternatively or additionally, the plurality of components (e.g., modules or programs) may be integrated into one component. In this case, the integrated component may perform one or more functions of each of the plurality of components identically or similarly to those performed by the corresponding component of the plurality of components before the integration. According to the embodiments disclosed herein, operations performed by modules, programs, or other components may be executed sequentially, in parallel, repeatedly, or heuristically, or one or more of the operations may be executed in a different order or omitted, or one or more other operations may be added.

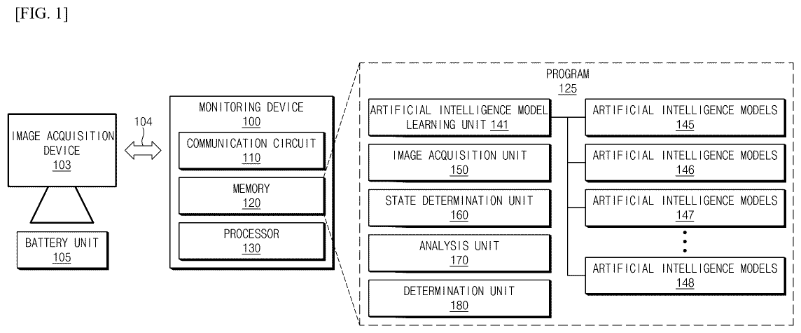

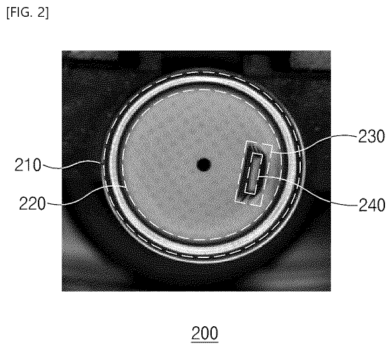

FIG. 1 is a block diagram showing a configuration of a monitoring device 100 according to one embodiment disclosed herein. FIG. 2 shows a can assembly 200 according to one embodiment disclosed herein.

In one embodiment, the monitoring device 100 may determine a state of a battery unit 105 based on an image of the battery unit 105 acquired by an image acquisition device 103. Here, the image acquisition device 103 may include a camera module. Here, the battery unit 105 may be a battery cell or the can assembly 200 included in the battery cell. Here, the can assembly 200 may include a cylindrical can 210, a top insulator (TI) 220, a hole 230 inside the TI 220, and a tab 240 exposed through the hole 230.

In one embodiment, the monitoring device 100 may determine the state of the battery unit 105 based on rule-based inspection results and/or artificial intelligence model-based inspection results for the battery unit 105. In one embodiment, the rule-based inspection may include the inspection of at least one of whether the TI 220 of the battery unit 105 is present, whether foreign substance is present in the TI 220, whether foreign substance is present outside the TI 220, or whether the TI 220 is lifted. In one embodiment, the artificial intelligence model-based inspection may include the inspection of at least one of whether the TI 220 is present, whether foreign substance is present in the TI 220, whether foreign substance is present outside the TI 220, whether the TI 220 is lifted, and whether beading cracks are present. According to the embodiment, items that may be inspected in the artificial intelligence model-based inspection may be more than items that may be inspected in the rule-based inspection. Here, the outside of the TI 220 is an area between an outer perimeter of the TI 220 and the cylindrical can 210 and may be an area in which the TI 220 is beaded to the cylindrical can 210. In addition, the inside of the TI 220 is an area within the outer perimeter of the TI 220 and may be an area within a beading area.

In one embodiment, the monitoring device 100 may determine that the state of the battery unit 105 is good when both the rule-based test result and the artificial intelligence model-based test result for the battery unit 105 indicate normal. In one embodiment, the monitoring device 100 may determine that the battery unit 105 is a defective product when at least one of the rule-based test result or the artificial intelligence model-based test result for the battery unit 105 indicates failure.

Hereinafter, components of the monitoring device 100 will be described schematically, and then a specific method of operating the monitoring device 100 will be described.

Referring to FIG. 1, the monitoring device 100 may include a communication circuit 110, a memory 120, and a processor 130. According to the embodiment, the monitoring device 100 illustrated in FIG. 1 may further include at least one component (e.g., a display, an input device, or an output device) other than the components illustrated in FIG. 1.

In one embodiment, the communication circuit 110 may establish a wired communication channel and/or wireless communication channel between the monitoring device 100 and the image acquisition device 103 and transmit and receive data with the image acquisition device 103 via the established communication channel.

In one embodiment, the memory 120 may include a volatile memory and/or a non-volatile memory.

In one embodiment, the memory 120 may store data used by at least one component (e.g., the processor 130) of the monitoring device 100. For example, the data may include a program 125 (or an instruction related thereto), input data, or output data. In one embodiment, the instruction may allow the monitoring device 100 to perform operations defined by the instruction when executed by the processor 130.

In one embodiment, the memory 120 may include the program 125 (e.g., an artificial intelligence model learning unit 141, artificial intelligence models 145, 146, 147, and 148, the image acquisition unit 150, a state determination unit 160, an analysis unit 170, and/or a determination unit 180).

In one embodiment, the processor 130 may include a central processing unit, an application processor, a graphics processing unit, a neural processing unit (NPU), an image signal processor, a sensor hub processor, or a communication processor.

In one embodiment, the processor 130 may control at least one another component (e.g., hardware or software component) of the monitoring device 100 connected to the processor 130 by executing the program 125 (e.g., the artificial intelligence model learning unit 141, the artificial intelligence models 145, 146, 147, and 148, the image acquisition unit 150, the state determination unit 160, the analysis unit 170, and/or the determination unit 180) and perform various data processing or calculation.

In one embodiment, the artificial intelligence model learning unit 141 may learn the artificial intelligence models 145, 146, 147, and 148 based on learning data. In one embodiment, the artificial intelligence models 145, 146, 147, and 148 may be models learned to generate output results for different purposes based on different learning data.

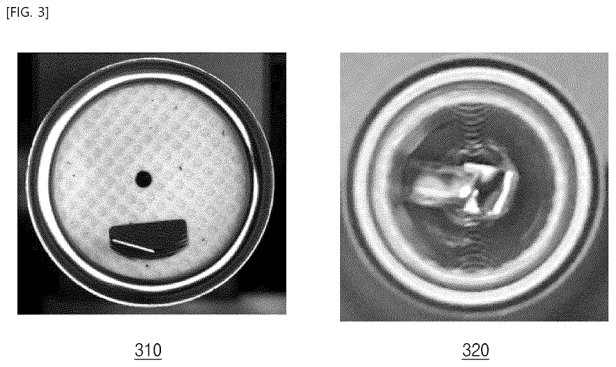

In one embodiment, the image acquisition unit 150 may acquire the image of the battery unit 105 from the image acquisition device 103. In one embodiment, the state determination unit 160 may determine the state of the TI 210 in the can assembly 200 based on the image of the battery unit 105. In one embodiment, the state determination unit 160 may determine the state of the TI 210 in the can assembly 200 by inputting the image of the battery unit 105 into the artificial intelligence models 145, 146, 147, and 148. In one embodiment, the analysis unit 170 may analyze the state of the TI 210 in the can assembly 200 by performing the rule-based inspection on the image of the battery unit 105. In one embodiment, the determination unit 180 may determine whether the battery unit 105 is a good product based on the results of the determination of the state determination unit 160 and/or the analysis unit 170. Hereinafter, a method of allowing the monitoring device 100 to determine the state of the battery unit 105 through the artificial intelligence model learning unit 141, the artificial intelligence models 145, 146, 147, and 148, the image acquisition unit 150, the state determination unit 160, the analysis unit 170, and/or the determination unit 180 will be described in detail with reference to FIG. 3 to FIG. 6.

### Learning of Artificial Intelligence Model

FIG. 3 is a view showing a battery unit having the IT and a battery unit without the TI according to one embodiment disclosed herein.

In one embodiment, the artificial intelligence model learning unit 141 may input the image of the battery unit into the artificial intelligence model 145. In one embodiment, the artificial intelligence model 145 may be a model (model based on a convolutional neural network (CNN)) capable of multinomial classification. In one embodiment, the artificial intelligence model 145 may be learned to classify whether the TI is present based on the images 310 and 320 of the battery unit.

In one embodiment, data for learning the artificial intelligence model 145 may include the image 310 of the battery unit in which the TI is normally present, and the image 320 without the TI. In one embodiment, the images 310 and 320 used for learning the artificial intelligence model 145 may be provided in advance.

In one embodiment, the artificial intelligence model 145 may be learned to classify an input image into at least two states based on learning data. Here, the at least two states may include a state in which the TI is normally present in the can assembly and a state without the TI in the can assembly.

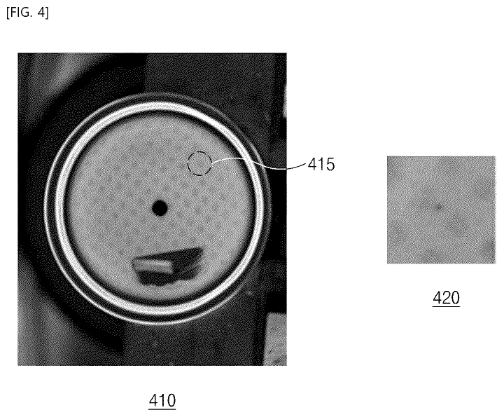

FIG. 4 shows an image showing foreign substance present inside the TI of the battery unit according to one embodiment disclosed herein. FIG. 4 includes an image 410 in which foreign substance 415 is present inside the TI, and an image 420 enlarging some area including the foreign substance 415 of the image 410.

In one embodiment, the artificial intelligence model learning unit 141 may input the image of the battery unit into the artificial intelligence model 146. In one embodiment, the artificial intelligence model 146 may be a model capable of multinomial classification. In one embodiment, the artificial intelligence model 146 may be learned to identify the foreign substance 415 based on the image 410 of the battery unit. Here, FIG. 4 shows only the image 410 in which the foreign substance 415 is present, but it is only an example. In one embodiment, the artificial intelligence model 146 may be learned to perform multinomial classification through the image 410 in which the foreign substance 415 is present and the image (not shown) without the foreign substance 415.

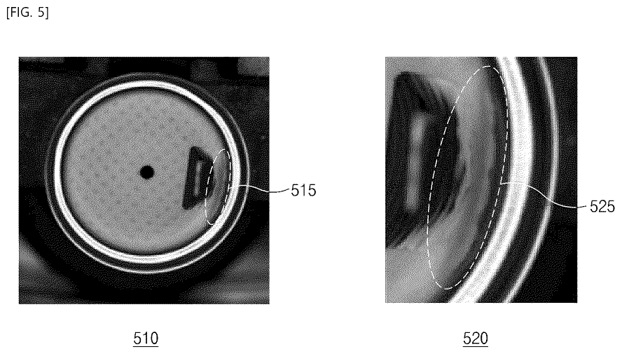

In one embodiment, the artificial intelligence model 146 may be learned to classify an input image into at least two states based on learning data. Here, the at least two states may include a state in which a foreign substance is present and a state without the foreign substance. FIG. 5 shows an image of the lifted TI of the battery unit according to one embodiment disclosed herein. FIG. 5 includes an image 510 in which lifting is present inside the TI, and an image 520 enlarging an area 515 in which lifting is present of the image 510.

In one embodiment, the artificial intelligence model learning unit 141 may input the image of the battery unit into the artificial intelligence model 147. In one embodiment, the artificial intelligence model 147 may be a model capable of multinomial classification. In one embodiment, the artificial intelligence model 147 may be learned to identify whether the lifting of the TI is present based on the image 510 of the battery unit. Here, the lifting of the TI may occur in an area adjacent to the cylindrical can among internal areas of the TI.

In one embodiment, data for learning the artificial intelligence model 147 may include the image 510 in which the lifting of the TI is present and an image (not shown) in which the lifting of the TI is not present. In one embodiment, the images used for learning the artificial intelligence model 147 may be provided in advance.

In one embodiment, the artificial intelligence model 147 may be learned to identify a lifted area 515 in the input image based on learning data.

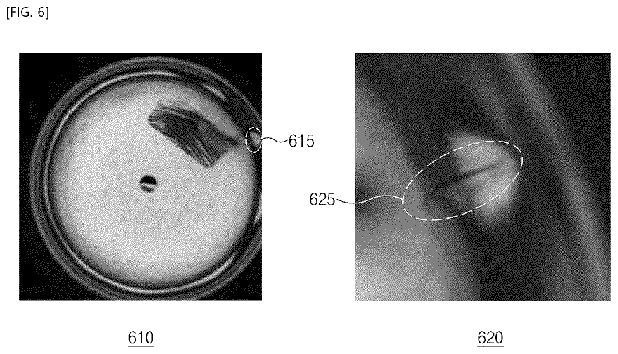

FIG. 6 is a view showing a state in which cracks are present in a beading area of the battery unit according to one embodiment disclosed herein. FIG. 6 includes an image 610 in which cracks are present in the beading area outside the TI, and an image 620 enlarging an area 615 in which the cracks are present of the image 610. Referring to the image 620, it can be seen that cracks are present in an area 625.

In one embodiment, the artificial intelligence model learning unit 141 may input the image of the battery unit into the artificial intelligence model 148. In one embodiment, the artificial intelligence model learning unit 141 may learn the artificial intelligence model 148 to classify the beading state in the can assembly of the battery unit based on the image 610. In one embodiment, the artificial intelligence model 148 may be a model capable of multinomial classification.

In one embodiment, data for learning the artificial intelligence model 148 may include the image 610 in which cracks are present in the beading area, and an image (not shown) in which the cracks are not present in the beading area. In one embodiment, the images used for learning the artificial intelligence model 148 may be provided in advance.

In one embodiment, the artificial intelligence model 148 may be learned to classify an input image into at least two states based on learning data. Here, the at least two states may include a state in which cracks are present in the beading area and a state in which the cracks are not present in the beading area.

### State Determination Through Artificial Intelligence Model

In one embodiment, the state determination unit 160 may determine the state of the can assembly based on the image of the battery unit 105. In one embodiment, the state determination unit 160 may determine the state of the can assembly by inputting the image of the battery unit 105 into the artificial intelligence model 145. In one embodiment, the state determination unit 160 may determine the state of the can assembly of the battery unit 105 based on the output of the artificial intelligence model 145. For example, the state determination unit 160 may determine the state of the can assembly of the battery unit 105 based on the state (e.g., whether the TI is present, whether foreign substance is present inside the TI, whether the foreign substance is present outside the TI, whether the lifting of the TI is present, or whether cracks are present in the beading area) of the battery unit 105 classified by the artificial intelligence models 145 to 148.

In one embodiment, when the TI is normally present in the battery unit 105, the state determination unit 160 may determine that the state of the can assembly is normal. In one embodiment, when the TI is not present, the state determination unit 160 may determine that the state of the can assembly is defective.

In one embodiment, when foreign substance is not present inside and/or outside the TI in the battery unit 105, the state determination unit 160 may determine that the state of the can assembly is normal. In one embodiment, when foreign substance is present inside and/or outside the TI, the state determination unit 160 may determine that the can assembly is in a defective state.

In one embodiment, when the TI is not lifted in the battery unit 105, the state determination unit 160 may determine that the state of the can assembly is normal. In one embodiment, when the TI is lifted, the state determination unit 160 may determine that the state of the can assembly is defective.

In one embodiment, when cracks are not present in the beading of the battery unit 105, the state determination unit 160 may determine that the state of the can assembly is normal. In one embodiment, when the cracks are present in the beading, the state determination unit 160 may determine that the can assembly is defective.

In one embodiment, the state determination unit 160 may transmit the state determination result of the battery unit 105 to the determination unit 180.

In one embodiment, the analysis unit 170 may analyze the state of the TI 210 in the can assembly 200 by performing the rule-based inspection on the image of the battery unit 105. Here, the rule-based inspection may be an inspection that determines whether the battery unit 105 is defective based on gray level information of the image of the battery unit 105.

For example, the analysis unit 170 may determine at least one of whether the TI 220 is present in the battery unit 105, whether foreign substance is present inside the TI 220, whether the foreign substance is present outside the TI 220, or whether lifting of the TI 220 is present based on the gray level information of the image of the battery unit 105 and generate the result of the determination. According to one embodiment, the analysis unit 170 may sequentially determine whether the TI 220 is present in the battery unit 105, whether foreign substance is present inside the TI 220, whether the foreign substance is present outside the TI 220, or whether lifting of the TI 220 is present based on the gray level information of the image of the battery unit 105.

In one embodiment, the analysis unit 170 may transmit the state determination result of the battery unit 105 to the determination unit 180.

In one embodiment, the number of inspection items that may be inspected by the state determination unit 160 may be greater than the number of inspection items that may be inspected by the analysis unit 170. That is, the number of inspection items based on the artificial intelligence model may be greater than the number of inspection items based on the gray level information. For example, while the state determination unit 160 may inspect whether cracks are present in the beading, the analysis unit 170 may not inspect the same.

In one embodiment, the determination unit 180 may determine whether the battery unit 105 is a good product based on the results of the determination of the state determination unit 160 and/or the analysis unit 170. For example, when the results of the determination of the state determination unit 160 and the analysis unit 170 all indicate normal, the determination unit 180 may determine that the battery unit 105 is a good product. For example, when the result of the determination of at least one of the state determination unit 160 or the analysis unit 170 indicates a defect, the determination unit 180 may determine that the battery unit 105 is not a good product.

As described above, according to the monitoring device 100 according to one embodiment disclosed herein, a defective battery unit may be detected by accurately analyzing the TI state of the battery unit.

In FIG. 1, the artificial intelligence models of program 125 are shown separately, but it is only an example. In one embodiment, the artificial intelligence models 145, 146, 147, and 148 may be implemented as one artificial intelligence model.

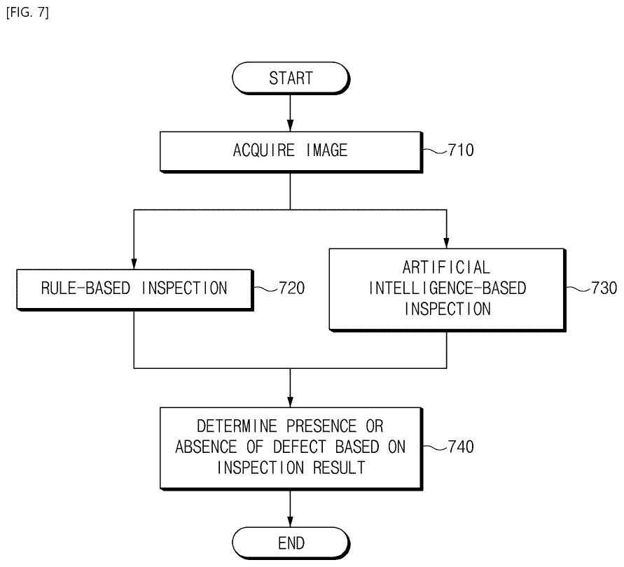

FIG. 7 is a view showing a method of operating the monitoring device 100 according to one embodiment disclosed herein. FIG. 7 may be described with reference to FIG. 1 to FIG. 6.

Referring to FIG. 7, in operation 710, the monitoring device 100 may acquire an image. Here, the image may be an image of the battery unit 105 acquired by the image acquisition device 103.

In operation 720, the monitoring device 100 may perform rule-based inspection. In one embodiment, the monitoring device 100 may perform the rule-based inspection based on gray level information of the image.

For example, the monitoring device 100 may determine at least any one of whether the TI 220 is present in the battery unit 105, whether foreign substance is present inside the TI 220, whether the foreign substance is present outside the TI 220, or whether lifting of the TI 220 is present based on the gray level information of the image of the battery unit 105 and generate the result of the determination. According to one embodiment, the monitoring device 100 may sequentially determine whether the TI 220 is present in the battery unit 105, whether foreign substance is present inside the TI 220, whether the foreign substance is present outside the TI 220, or whether lifting of the TI 220 is present based on the gray level information of the image of the battery unit 105.

In operation 730, the monitoring device 100 may perform artificial intelligence model-based inspection. For example, the monitoring device 100 may perform the artificial intelligence model-based inspection of the image based on the previously learned artificial intelligence models 145, 146, 147, and 148.

In one embodiment, the monitoring device 100 may determine the state of the can assembly by inputting the image of the battery unit 105 into the artificial intelligence model 145. In one embodiment, the monitoring device 100 may determine the state of the can assembly of the battery unit 105 based on the output of the artificial intelligence model 145. For example, the monitoring device 100 may determine the state of the can assembly of the battery unit 105 based on the state (e.g., whether the TI is present, whether foreign substance is present inside the TI, whether the foreign substance is present outside the TI, whether the lifting of the TI is present, or whether cracks are present in the beading area) of the battery unit 105 classified by the artificial intelligence models 145 to 148.

In one embodiment, when the TI is normally present in the battery unit 105, the monitoring device 100 may determine that the state of the can assembly is normal. In one embodiment, when the TI is not present, the monitoring device 100 may determine that the state of the can assembly is defective.

In one embodiment, when foreign substance is not present inside and/or outside the TI in the battery unit 105, the monitoring device 100 may determine that the state of the can assembly is normal. In one embodiment, when foreign substance is present inside and/or outside the TI, the monitoring device 100 may determine that the state of the can assembly is defective.

In one embodiment, when the TI is not lifted in the battery unit 105, the monitoring device 100 may determine that the state of the can assembly is normal. In one embodiment, when the TI is lifted, the monitoring device 100 may determine that the state of the can assembly is defective.

In one embodiment, when cracks are not present in the beading of the battery unit 105, the monitoring device 100 may determine that the state of the can assembly is normal. In one embodiment, when the cracks are present in the beading, the monitoring device 100 may determine that the state of the can assembly is defective.

In operation 740, the monitoring device 100 may determine the presence or absence of a defect based on the inspection result.

In one embodiment, the monitoring device 100 may determine that the state of the battery unit 105 is a good product when both the rule-based inspection result and the artificial intelligence model-based inspection result all indicate normal.

1. A monitoring device comprising:
an image acquisition unit configured to capture an image of at least one process processing device involved in manufacturing of a battery cell;
a state determination unit configured to generate a first determination result by analyzing the acquired image using an artificial intelligence model trained to assess a condition of a top insulator of the battery cell and determine whether the battery cell is defective; and
a determination unit configured to determine whether the battery cell is defective based on the first determination result.

2. The monitoring device of claim 1, further comprising an analysis unit configured to generate a second determination result by evaluating whether the battery cell is defective based on gray level information of the acquired image,
wherein the determination unit determines whether the battery cell is defective based on both the first determination result and the second determination result.

3. The monitoring device of claim 2, wherein a number of inspection items based on the artificial intelligence model is greater than a number of inspection items based on the gray level information.

4. The monitoring device of claim 1, wherein the artificial intelligence model is configured to detect, based on the acquired image, at least one of the following conditions: presence of the top insulator in the battery cell, presence of foreign substances inside the top insulator, presence of foreign substances outside the top insulator, and lifting of the top insulator.

5. The monitoring device of claim 1, wherein the artificial intelligence model is configured to detect, based on the acquired image, presence of cracks in a beading of the battery cell.

6. A method of operating a monitoring device, comprising:
capturing an image of at least one process processing device involved in manufacturing of a battery cell;
generating a first determination result by analyzing the acquired image into using an artificial intelligence model trained assess a condition of a top insulator of the battery cell and determine whether the battery cell is defective; and
determining whether the battery cell is defective based on the first determination result.

7. The method of claim 6, further comprising generating a second determination result by evaluating whether the battery cell is defective based on gray level information of the acquired image,
wherein determining whether the battery cell is defective includes evaluating both the first determination result and the second determination result.

8. The method of claim 7, wherein a number of inspection items based on the artificial intelligence model is greater than a number of inspection items based on the gray level information.

9. The method of claim 6, wherein the artificial intelligence model is configured to detect, based on the acquired image, at least one of the following conditions: presence of the top insulator in the battery cell, presence of foreign substance inside the top insulator, presence of foreign substances outside the top insulator, and lifting of the top insulator.

10. The method of claim 6, wherein the artificial intelligence model is configured to detect, based on the acquired image, presence of cracks in a beading of the battery cell.
